(19) United States
(12) Patent Application Publication
(10) Pub. No.: US 2022/0085542 A1
(43) Pub. Date: Mar. 17, 2022

(54) SAFETY SYSTEM FOR ELECTRICAL SOCKETS

(71) Applicant: Darryl Watson, II, New Orleans, LA (US)

(72) Inventor: Darryl Watson, II, New Orleans, LA (US)

(21) Appl. No.: 16/948,378

(22) Filed: Sep. 16, 2020

(51) Int. Cl. H01R 13/453; H01R 13/713; H01R 13/703

(52) U.S. Cl. CPC H01R 13/4532; H01R 13/703; H01R 13/713

(57) ABSTRACT

A plug and socket safety system, wherein a socket element is not energized unless both engaged with the plug element and moved to an energized, locked position, and wherein the plug element cannot be removed from the socket element until the socket element is moved to a neutral, unenergized, unlocked position.

### BACKGROUND OF THE INVENTION

The present invention relates to security and safety systems for electrical sockets and, more particularly, a plug and socket upgrade that only allows power only upon a certain plug key is inserted and successfully unlocks a locking mechanism so that the socket lock can be moved to a locked, energized position, only then enabling an electrical connection between the socket lock and the inserted plug key, and wherein the plug key cannot be removed while in the locked position.

Traditionally, improper ejection of prongs from electrical sockets has been the bane of many a user of electrically power devices. At the same time, concerns about child safety and home fires from electrical socket malfunctions is almost as ubiquitous as the electrical socket itself.

Currently, the electrical socket near you is fixed on equipment or a building structure and electrically connected to an energized electrical circuit driven by hundreds of volts of power. Mere contact with the energized electrical circuit, through a female contact of the energized socket can result in the flow of electrical power, sufficient to cause injurious electrical shock to a living creature and start an electrical fire against a suitable inanimate object. Covers, shutters and other mechanisms have been added to such ‘live’ sockets, but these prophylactic elements have the disadvantages of getting in the way, requiring more time and effort to secure a simple electric connection, and, if they malfunction, can render the socket inaccessible.

As mentioned above, today's electric sockets are prone to unintentional disconnections of the intended male contact of the to-be powered equipment plug from the socket. Either due to wear and tear or poor original design, the socket's female contacts can fail to securely engage the plug's male contact, whereby even the slightest pull on the plug results in said electrical disconnection as the plug's male contacts cannot contact the energized electrical circuit through the socket's female contacts. Murphy's law dictates that this tends to happen when one least wants it to happen.

As can be seen, there is a need for an electrical socket and plug system embodying a socket lock element and a plug key element, wherein the plug key is energized only when both an insert and a locked position is realized. The plug key element may provide bittings, which are required to move the socket lock element to the locked position, which is needed to activate a switch or otherwise close the underlying socket electrical circuit that energizes the female contact and thus the plug key element is received in. In certain embodiments, the plug key element enables the socket lock element to move between an unlocked, unenergized condition and a locked, energized condition through rotation of the socket face of the lock element. In this embodiment, only when the socket face has made a 90-degree turn does electricity flow from the socket female contact to the plug male contact. As a result, no other “plug” is enabled to turn the socket face—even if a highly conductive “foreign object” is inserted, no electricity is flowing as the socket face cannot turn.

The present invention does not have constant energized sockets, and so a cover or other external safety features are not needed. The built-in safety feature in the present invention allows mistakes to happen without suffering dangerous unintended consequence. Children often put things into sockets not knowing these possible consequences, the present invention prevents this. Also, the present invention prevents a socketed plug from being yanked out of a wall because once the plug is turned, the plug does not come out until the socket lock element is turned back to its neutral, unlocked, unenergized position.

### SUMMARY OF THE INVENTION

In one aspect of the present invention, a safety system for an electrical socket includes the following: a plug having one or more prongs; a socket face having one or more female contacts; the socket face movable between a first position and a second position only when each female contact is in receipt of one of the one or more prongs; and each female contact not energized in the first position.

In another aspect of the present invention, a safety system for an electrical socket includes a turn-and-lock configuration.

In yet another aspect of the present invention, a safety system for an electrical socket includes the following: a plug having one or more prongs; bittings along at least one prong of the one or more prongs; a socket face having one or more female contacts; the socket face movable between a first position and a second position only when each female contact is in receipt of one of the one or more prongs, and wherein the bittings matches a predetermined a correct bittings; the first position is oriented ninety degrees about a rotational axis relative to the second position, and wherein each received prong is locked into the female contact when the socket face is in the second position; and each female contact not energized in the first position, wherein the second position energizes each female contact, and wherein each received prong is locked into the female contact when the socket face is in the second position.

These and other features, aspects and advantages of the present invention will become better understood with reference to the following drawings, description and claims.

### BRIEF DESCRIPTION OF THE DRAWINGS

FIG. 1 is an exploded perspective view of an exemplary embodiment of the present invention;

FIG. 2 is a perspective view of an exemplary embodiment of the present invention;

FIG. 3 is a front elevation view of an exemplary embodiment of the present invention; and

FIG. 4 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a plug and socket safety system, wherein the socket element is not energized unless both engaged with the plug element and moved to an energized, locked position, and wherein the plug element cannot be removed from the socket element until the socket element is moved to a neutral, unenergized, unlocked position.

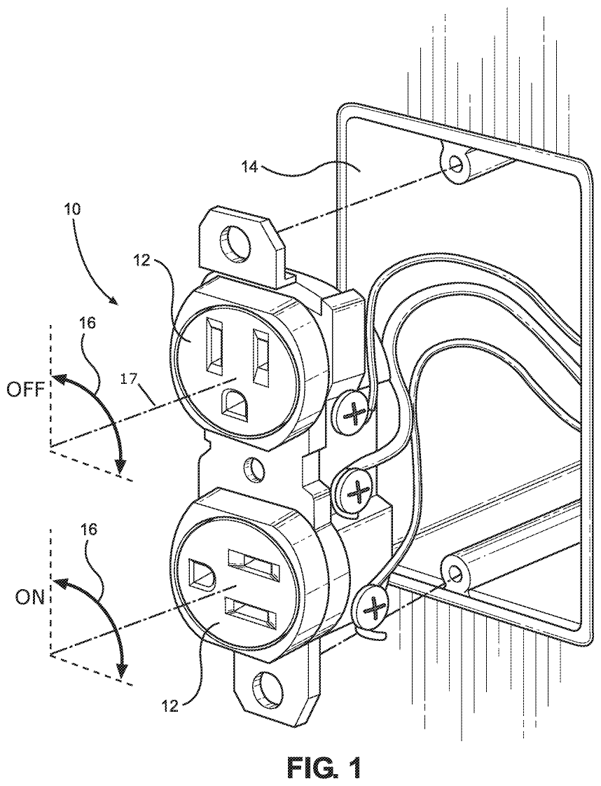

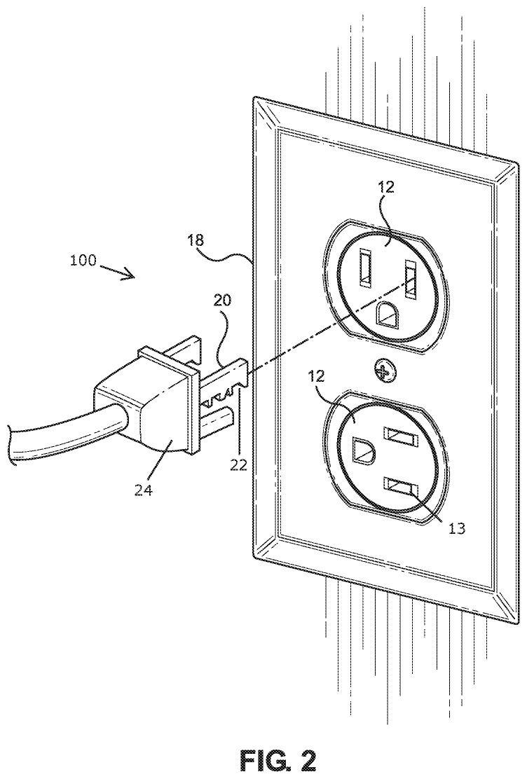

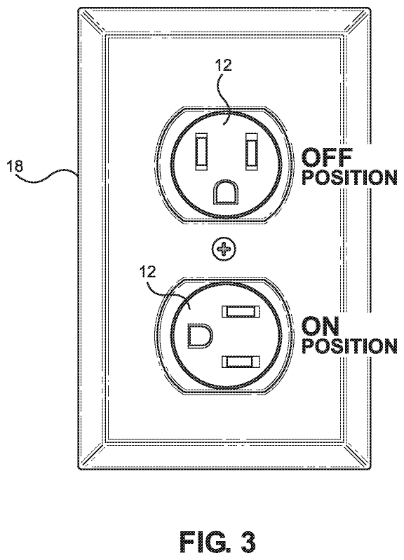

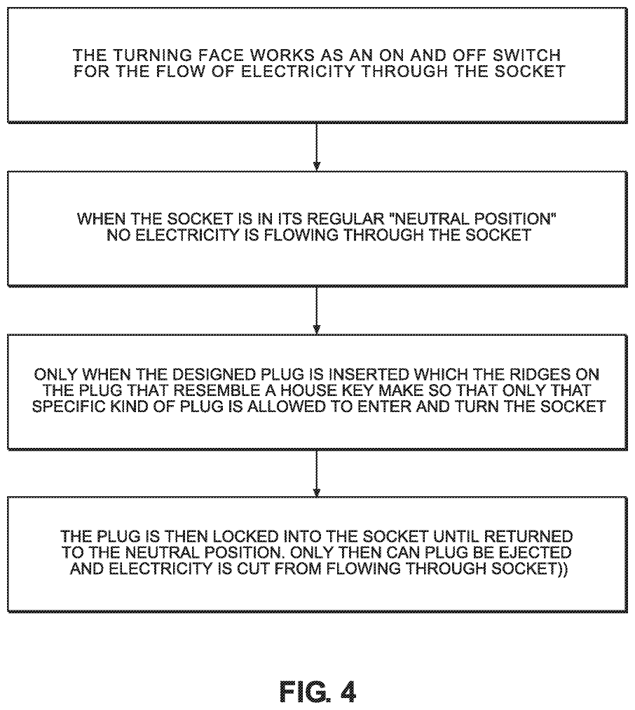

Referring now to FIGS. 1 through 4, the present invention may include a socket-plug electrical connection system 100 embodying a socket lock 10 and a plug key 24, wherein the socket lock 10 is energized only when both the plug key is inserted in the socket face 12 of the socket lock 10 and when the socket face 12 is moved to an energized, locked position. In the energized, locked position, the plug key 24 cannot be removed from the socket face 12.

The plug key 24 of the socket-plug electrical connection system 100 may include one or more prongs 20. The one or more prong/blade portions 20 may be disposed in one of many possible prong/blade portion arrangements. Each prong 20 may provide bittings 22, such as a series of pointed teeth and notches on a blade portion of the plug key 20. One prong 20 may be a ground prong. The prong 20 are the male contacts.

The socket lock 10 of the socket-plug electrical connection system 100 may include one or more socket faces 12 adapted to be electrically connected to a power supply while being housed in an outlet box 14 that is covered by a faceplate 18, but only when the relevant socket face is in an energized, locked position. The socket face 12 provides one or more female contacts 13 dimensioned and adapted to receive the one or more respective prongs 20.

Each socket face 12 is adapted to be moved between a neutral, unenergized, unlocked position and the energized, locked position, in certain embodiments, in a rotational direction 16 along a rotational axis 17. In some embodiments a pivot (not shown) integrated to the socket lock 10 enables the rotational direction 16. The socket lock 10 may include a physical locking mechanism (not shown), such as a movable bolt operatively associated with an internal tumbler, or the like, that prevents the rotational direction 16 in the absence of the proper prong(s) 20 received in the female contact(s) 13. And in certain embodiments, only a prong 20 with the correct bittings 22 can engage the locking mechanism enabling movement of the socket face 12 along the rotational direction 16.

Furthermore, the physical locking mechanism is adapted to prevent removal of the prong/blade portion 20 (male contact) from the female contact 13 in the locked, energized (‘ON’) position. Thus the locking mechanism is similar to the turn-and-lock technology used in cars, as in a physical key is needed to be engaged in the ignition to start the engine and the key an not be removed from the ignition while the engine was running.

In the unlocked, neutral (‘OFF’) position, illustrated in FIG. 1 as at “12 o'clock”, the prong 20 (male contact) is free to be inserted and removed from the female contact 13 just like conventional electrical sockets.

The socket lock 10 may have a switch (not shown) that is off/disengaged when the socket face 12 is in the neutral, unenergized, unlocked position but is on/engaged when the socket face 12 is in the locked, energized position so that current is flowing to the female contacts 13.

These two facets work together to increase the overall safety of this simple process in everyone's life. The turning socket face 12 works as an on and off switch for the flow of electricity through the socket's female contacts 13. When the socket face 12 is in its regular “neutral position” no electricity is flowing through the socket's female contacts 13. Only when the designed plug key 24 is inserted (and wherein the bittings 22 on the plug's prong blades 20 are allowed by the physical locking mechanism to move the socket face 12 about the pivot to the energized, locked position) is the plug key component 24 locked into the socket until the socket face 12 is returned to the neutral position. Only then can the plug key 24 be ejected and electricity is cut from flowing through the socket's female contacts 13.

A method of making the present invention may include the following. A manufacturer would start by making a separate socket body from the face guard, similar to the way a normal plug and socket is made. The functionality of the socket not allowing electricity to flow unless turned by the designed plug could track the design of the turn-and-lock configurations mentioned above. A sensor is optional, wherein the sensor may be adapted to automatically turn socket off if surge happens. Instead of turning the plug to the right to be in the energized, locked position, the present invention can be reconfigured to turn to the left. The manufacturer could also change the plug and socket design or locking system style.

A method of using the present invention would include the following. The socket-plug electrical connection system 100 disclosed above may be provided. A user could remove and replace their old electric socket with the socket-plug electrical connection system 100 of the present invention. One would use it in the normal way one uses sockets today, but just simply adds a turn of the wrist.

Additionally: the present invention could be used in various industrial field as a safety precaution for all electrical power connections.

It should be understood, of course, that the foregoing relates to exemplary embodiments of the invention and that modifications may be made without departing from the spirit and scope of the invention as set forth in the following claims.

What is claimed is:

1. A safety system for an electrical socket comprising:
a plug having one or more prongs;
a socket face having one or more female contacts;
the socket face movable between a first position and a second position only when each female contact is in receipt of one of the one or more prongs; and
each female contact not energized in the first position.

2. The safety system of claim 1, further comprising bittings along at least one prong of the one or more prongs.

3. The safety system of claim 1, wherein the first position is oriented forty-five to one-hundred and thirty-five degrees about a rotational axis relative to the second position.

4. The safety system of claim 1, wherein the first position is oriented ninety degrees about a rotational axis relative to the second position.

5. The safety system of claim 1, wherein each received prong is locked into one female contact of the one or more female contacts when the socket face is in the second position.

6. The safety system of claim 1, wherein each received prong is locked into the female contact of the one or more female contacts when the socket face is in the second position.

7. The safety system of claim 1, wherein the second position energizes each female contact.

8. A safety system for an electrical socket comprising a turn-and-lock configuration.

9. A safety system for an electrical socket comprising:
a plug having one or more prongs;
bittings along at least one prong of the one or more prongs;
a socket face having one or more female contacts;
the socket face movable between a first position and a second position only when each female contact is in receipt of one of the one or more prongs, and wherein the bittings matches a predetermined a correct bittings;
the first position is oriented ninety degrees about a rotational axis relative to the second position, and wherein each received prong is locked into the female contact when the socket face is in the second position; and
each female contact not energized in the first position, wherein the second position energizes each female contact, and wherein each received prong is locked into the female contact when the socket face is in the second position.
